(19) United States
(12) Patent Application Publication
(10) Pub. No.: US 2004/0126306 A1
(43) Pub. Date: Jul. 1, 2004

(54) Method of manufacturing graphite particles and refractory using the method

(76) Inventors: Tsunemi Ochiai, Takatsuki-shi (JP); Shigeyuki Takanaga, Bizen-shi (JP); Manshi Ohyanagi, Otsu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/469,838

(22) PCT Filed: Mar. 6, 2002
(86) PCT No.: PCT/JP02/02087

(30) Foreign Application Priority Data
Mar. 8, 2001 (JP) 2001-65385

(51) Int. Cl. C01B 31/04

(52) U.S. Cl. 423/448

(57) ABSTRACT

A process for producing graphite grains, characterized by graphitizing carbon black by induction heating. A process in which at least one element selected from metals, boron and silicon is contained in graphite grains is preferable. Refractories obtained by molding a composition containing a refractory filler and the graphite grains produced by the foregoing process are excellent in thermal shock resistance, oxidation resistance and corrosion resistance. Consequently, a process for producing graphite grains in which the graphitization of carbon black that requires quite a high temperature in an ordinary heating method can easily proceed is provided. Further, refractories excellent in thermal shock resistance, oxidation resistance and corrosion resistance and having a low carbon content are provided.

### TECHNICAL FIELD

The present invention relates to a process for producing graphite grains, particularly to a process for producing graphite grains, which comprises graphitizing carbon black by induction heating in an induction furnace. Especially, it relates to a process for producing “composite graphite grains” which are graphite grains containing at least one element selected from metals, boron and silicon. Further, it relates to refractories containing the graphite grains obtained by the foregoing process.

### BACKGROUND ART

Carbon black is quite a fine carbonaceous powder having a grain size of, usually less than 1 μm. Currently, carbon black has been marketed with various grain sizes in various forms, and has found wide acceptance in ink, rubber fillers and the like. It has been known that when this carbon black is heated at a high temperature, a graphite structure is formed and graphitized fine grains are obtained.

Official gazette of JP-A-2000-273351 discloses a process for producing graphitized carbon black, which comprises heat-treating a mixture containing carbon black and a graphitization-promoting substance at from 2,000 to 2,500° C. The temperature of approximately 2,800° C. so far required for graphitization of carbon black can be reduced to from 2,000 to 2,500° C. by heating along with a graphitization-promoting substance made of an element such as boron, silicon, aluminum or iron or its compound.

Since carbon has a high thermal conductivity and a property that it is hardly wetted with a melt such as a slag, carbon-contained refractories have an excellent durability. Accordingly, in recent years, they have been widely used as lining refractories of various molten metal containers. For example, when magnesia is used as a refractory filler, an excellent durability is exhibited as lining refractories of molten metal containers because of the property provided by carbon and a corrosion resistance to melt provided by magnesia.

However, as carbon-contained refractories have been increasingly used, elution of carbon of refractories in molten steel which is so-called carbon pickup has been problematic. Especially, in recent years, high-quality steel has been required more severely, and refractories having a lower carbon content has been in high demand. Meanwhile, from the aspect of inhibition of heat dissipation from containers or environmental protection such as energy saving, the use of refractories having a low thermal conductivity has been required. From this standpoint as well, refractories having a low carbon content has been demanded.

As carbonaceous raw materials used in carbon-contained refractories, flake graphite, a pitch, a coke, mesocarbon and the like have been so far mainly used. For obtaining refractories having a low carbon content, the mere reduction of the use amount of these carbonaceous raw materials has involved a problem of the decrease in thermal shock resistance. In order to solve this problem, official gazette of JP-A-5-301772 proposes refractories in which expanded graphite is used as a carbonaceous raw material. Examples thereof describe a magnesia carbon brick obtained by kneading a refractory raw material composition comprising 95 parts by weight of sintered magnesia, 5 parts by weight of expanded graphite and 3 parts by weight of a phenol resin, press-molding the composition and then heat-treating the molded product at 300° C. for 10 hours. It is described that a spalling resistance is improved in comparison to the use of the same amount of flake graphite.

Official gazette of JP-A-11-322405 discloses carbon-contained refractories having a low carbon content, characterized in that in a raw material blend comprising a refractory raw material and a carbonaceous raw material containing carbon, a fixed carbon content of the carbonaceous raw material is from 0.2 to 5% by weight per 100% by weight of a hot residue of the raw material blend and carbon black is used in at least a part of the carbonaceous raw material (claim 5). In the official gazette, it is explained that since carbon black has a very small grain size, a dispersibility in a refractory texture is significantly high, surfaces of filler grains can be coated with fine carbon grains, and the contact of filler grains can be blocked even at a high temperature over a long period of time to inhibit excessive sintering. Examples describe refractories formed by molding a raw material blend obtained by blending a refractory filler comprising 50 parts by weight of magnesia and 50 parts by weight of alumina with 2.5 parts by weight of a phenol resin, 1 part by weight of a pitch and 1 part by weight of carbon black (thermal) and baking the molded product at from 120 to 400° C., indicating that the refractories are excellent in spalling resistance and resistance to oxidative damage.

Official gazette of JP-A-2000-86334 describes a brick for a sliding nozzle apparatus obtained by adding from 0.1 to 10% by weight, based on outer percentage, of carbon black having a specific surface area of 24 m²/g or less to a blend comprising are fractory filler and a metal, further adding an organic binder, kneading the mixture, molding the resulting mixture and then heat-treating the molded product at a temperature of from 150 to 1,000° C. It is indicated that the incorporation of specific carbon black in a spherical form having a large grain size provides a good packing property and a dense brick texture to decrease a porosity and used carbon black itself is also excellent in oxidation resistance, whereby refractories excellent in oxidation resistance are obtained. Examples describe refractories obtained by molding a blend comprising 97 parts by weight of alumina, 3 parts by weight of aluminum, 3 parts by weight of a phenol resin, 3 parts by weight of a silicon resin and 3 parts by weight of carbon black and heating the molded product at a temperature of 500° C. or less, indicating that the refractories are excellent in oxidation resistance.

However, in the process in which carbon black and a graphitization-prompting substance such as boron are heat-treated for graphitization as described in official gazette of JP-A-2000-273351, the heating temperature of from 2,000to2,500° C. was still required. Considering the industrial production, the heating at a temperature exceeding 2,000° C. increases an energy load which leads to the increase in cost. Graphitization of carbon black alone without containing the graphitization-prompting substance required a higher temperature. Besides, the heating at such a high temperature greatly restricted a heating container, a furnace material and the like.

Moreover, the graphitized carbon black described in official gazette of JP-A-2000-273351 is used in a carrier for a catalyst of a phosphoric acid-type fuel cell, and there is nothing to describe or suggest that such a graphitized carbon black is useful as a raw material of refractories.

As described in JP-A-5-301772, the use of expanded graphite as a carbonaceous raw material can provide a good thermal shock resistance even in low-carbon refractories in which the use amount thereof is approximately 5% by weight as compared to the use of flake graphite in the same amount. Nevertheless, expanded graphite is a highly bulky raw material. Accordingly, even when the use amount is as small as approximately 5% by weight, a packing property of refractories is decreased, and a corrosion resistance to melt is poor. Moreover, the oxidative loss of the carbonaceous raw material during use of refractories was also a serious problem.

Official gazettes of JP-A-11-322405 and JP-A-2000-86334 disclose examples of using carbon black as a carbonaceous raw material. In both of these official gazettes, the employment of carbon black was deemed to improve a spalling resistance, but a corrosion resistance and an oxidation resistance were still insufficient.

The invention has been made to solve the foregoing problems, and it is to provide a process in which carbon black is graphitized by induction heating. Further, it is to provide a process for producing “composite graphite grains” which are graphite grains containing at least one element selected from metals, boron and silicon, simultaneously with the graphitization by induction heating. The other object of the invention is to provide carbon-contained refractories excellent in corrosion resistance, oxidation resistance and thermal shock resistance.

### DISCLOSURE OF THE INVENTION

The foregoing problems are solved by providing a process for producing graphite grains, characterized by graphitizing carbon black by induction heating in an induction furnace. The employment of such a heating method can easily proceed with the graphitization which requires quite a high temperature in an ordinary heating method. At this time, it is preferable to graphitize carbon black having an average grain size of 500 nm or less.

A process for producing graphite grains containing at least one element selected from metals, boron and silicon by induction heating of carbon black and a simple substance of at least one element selected from metals, boron and silicon or a compound containing the element is preferable. This is because incorporation of such an element except carbon in the graphite grains increases the oxidation-initiating temperature of the graphite grains, improves the oxidation resistance and the corrosion resistance and also improves the oxidation resistance and the corrosion resistance of refractories obtained by using the graphite grains as a raw material.

A process for producing graphite grains by induction heating of carbon black and a simple substance of at least one element selected from boron, aluminum, silicon, calcium, titanium and zirconium is also preferable. This is because the heating with the simple substance of the element can proceed with the reaction using heat generation in forming a carbide and the graphitization can easily be performed by a self-burning synthesis method using this reaction heat.

A process for producing graphite grains by induction heating of carbon black and an alcoholate of at least one element selected from metals, boron and silicon is also preferable. This is because when an element which is dangerous in the form of a simple substance due to easy explosion is formed into an alcoholate, it becomes easy to handle and a risk of dust explosion or the like is reduced.

A process for producing graphite grains by induction heating of carbon black, an oxide of at least one element selected from metals, boron and silicon and a metal reducing the oxide is also preferable. This is because with such a combination the element constituting the oxide can easily be reduced and contained in graphite.

A refractory which is obtained by molding a composition containing a refractory filler and the graphite grains produced by the foregoing process is a useful embodiment of the invention. Since the graphite grains are developed in crystal structure as compared to carbon black, they are a material which has a high oxidation-initiating temperature, is excellent in oxidation resistance and also in corrosion resistance and has a high thermal conductivity. The use of fine graphite grains in the nanometer order can divide pores to control the porous structure and further improve the corrosion resistance and the oxidation resistance of grains per se, with the result that a refractory excellent in thermal shock resistance, corrosion resistance and oxidation resistance is obtained.

The invention is described in detail below.

The invention is a process for producing graphite grains, characterized by graphitizing carbon black by induction heating in an induction furnace. Carbon black is carbonaceous fine grains with the grain size in the nanometer order which can currently be procured easily and products with various trade names can easily be obtained according to purposes in view of a grain size, an aggregation condition, a surface condition and the like. For example, it was already known that carbon black itself is used as a refractory raw material as described in column Prior Art. However, carbon black was insufficient in corrosion resistance and oxidation resistance. By graphitizing it, the crystal structure is developed, and a material which is high in oxidation-initiating temperature, excellent in oxidation resistance and also in corrosion resistance and high in thermal conductivity can be formed.

Carbon black used as a raw material is not particularly limited, and it is preferable to graphitize carbon black having an average grain size of 500 nm or less. The use of the graphite grains having such a fine grain size as a refractory raw material can provide a fine porous structure in the matrix of refractories. Flake graphite and expanded graphite used so far as a refractory raw material both had an average grain size greatly exceeding 1 μm and could not develop a fine porous structure in the matrix. Such a porous structure can be realized upon using the fine graphite grains of the invention.

The average grain size of carbon black as a raw material is preferably 200 nm or less, more preferably 100 nm or less. Further, the average grain size is usually 5 nm or more, preferably 10 nm or more. When the average grain size exceeds 500 nm, a fine porous structure cannot be provided when carbon black is used as a refractory raw material. When it is less than 5 nm, carbon black is difficult to handle. The average grain size here referred to indicates a number average grain size of primary grains of graphite grains. Accordingly, in case of, for example, grains having a structure that plural primary grains are aggregated, a number average grain size is calculated on condition that plural primary grains constituting the same are contained. Such a grain size can be measured by observation with an electron microscope.

With respect to carbon black as a raw material, specifically any of furnace black, channel black, acetylene black, thermal black, lamp black, Ketjen black and the like can be used.

Preferable examples thereof include various carbon blacks such as first extruding furnace black (FEF), super abrasion furnace black (SAF), high abrasion furnace black (HAF), fine thermal black (FT), medium thermal black (MT), semi-reinforcing furnace black (SRF) and general-purpose furnace black(GPF). At this time, plural types of carbon blacks may be blended and used as a raw material.

The invention is a process for producing graphite grains, characterized in that the foregoing carbon black is used as a raw material and graphitized by induction heating in an induction furnace. The induction heating is a method in which a temperature of a substance is increased by an induced current which a magnetic field changed with time induces in a conductor to allow heating. That is, carbon black is graphitized by induction heating of carbon black in an induction furnace which an induced current can be generated.

The structure of the induction furnace used for graphitization is not particularly limited. A structure is mentioned in which a heating unit formed of a conductor is mounted inside a coil formed of a conductor such as a copper wire and an AC current is passed through the coil for heating. In this structure, a current having a specific frequency, for example, a high frequency current, is passed through the coil to change a magnetic field in the coil according to the frequency, whereby an induced current is passed through the heating unit which then generates heat. Since a heating unit that endures a high temperature is required in the invention, it is advisable that the heating unit is made of carbon. Further, since carbon black is a fine powder, it is advisable to use a heating unit that takes the shape of a container capable of charging this carbon black.

By the graphitization of carbon black, a peak ascribable to a crystal structure is observed in the X-ray diffraction measurement. As the graphitization proceeds, lattice spacing is shortened. A 002 diffraction line of graphite shifts to a wide-angle region as the graphitization proceeds, and a diffraction angle 2θ of this diffraction line corresponds to the lattice spacing (average spacing). In the invention, it is preferable to use graphite of which the lattice spacing d is 3.47 Å or less. When the lattice spacing exceeds 3.47 Å, the graphitization is insufficient. For example, when carbon black is used as a refractory raw material, the thermal shock resistance, the oxidation resistance and the corrosion resistance might be insufficient.

In the invention, a process for producing graphite grains containing at least one element selected from metals, boron and silicon by induction heating of carbon black and a simple substance of at least one element selected from metals, boron and silicon or a compound containing the element is preferable. At this time, it is preferable that an element except carbon is contained by a burning synthesis method in the induction heating. Formation of, so to speak, “composite graphite grains” in which graphite grains contain such an element except carbon increases the oxidation-initiating temperature of graphite grains, improves the oxidation resistance and the corrosion resistance and also improves the oxidation resistance and the corrosion resistance of refractories obtained by using the composite graphite grains as a raw material.

Specific examples of at least one element which is contained in the graphite grains and selected from metals, boron and silicon here include elements such as magnesium, aluminum, calcium, titanium, chromium, cobalt, nickel, yttrium, zirconium, niobium, tantalum, molybdenum, tungsten, boron and silicon. Of these, for improving the oxidation resistance and the corrosion resistance of refractories, boron, titanium, silicon, zirconium and nickel are preferable, and boron and titanium are most preferable.

The way in which each element is present in the graphite grains is not particularly limited, and it may be contained within the grains or so as to cover surfaces of grains. Further, each element can be contained as an oxide, a nitride, a borate or a carbide thereof. It is preferably contained as a compound such as an oxide, a nitride, a borate or a carbide. It is more preferably contained as a carbide or an oxide. B₄C. or TiC is shown as a carbide, and Al₂O₃ is shown as an oxide.

The carbide is properly contained in the graphite grains in a form bound to a carbon atom constituting graphite. It is, however, undesirable that the total amount of the graphite grains is contained as the carbide because properties as graphite cannot be exhibited. Thus, it is necessary that the graphite grains have the crystal structure of graphite. The condition of such graphite grains can be analyzed by X-ray diffraction. For example, besides the peak corresponding to the crystal of graphite, a peak corresponding to the crystal of the compound such as TiC or B₄C. is observed.

A process for producing graphite in which graphite grains containing at least one element selected from metals, boron and silicon is produced by induction heating of carbon black and a simple substance of at least one element selected from metals, boron and silicon is preferable. This is because by heating with a simple substance of an element, the reaction can proceed with heat generated during formation of a carbide through burning synthesis. Specifically, a process for producing graphite grains by induction heating of carbon black and a simple substance of at least one element selected from boron, aluminum, silicon, calcium, titanium and zirconium is preferable. This is because these elements can form a carbide and the synthesis is enabled by a self-burning synthesis method using the heat of this reaction. Since the reaction heat of its own can be utilized, the temperature inside the furnace can be reduced as compared to the case of graphitizing carbon black alone.

For example, a reaction formula of the burning synthesis of boron and carbon and a reaction formula of the burning synthesis of titanium and carbon are as follows.

4B+xC→B₄C+(x−1)C

Ti+xC→TiC+(x−1)C

Both of these reactions are exothermic reactions which allow self-burning synthesis.

A process for producing graphite grains in which graphite grains containing at least one element selected from metals, boron and silicon are produced by induction heating of carbon black and an alcoholate of at least one element selected from metals, boron and silicon is also preferable because heat generated by burning synthesis can be used. This is because when an element which is dangerous in the form of a simple substance due to easy explosion is formed into an alcoholate, it becomes easy to handle and a risk of dust explosion or the like is reduced.

The alcoholate here referred to is a compound in which hydrogen of a hydroxyl group of an alcohol is substituted with at least one element selected from metals, boron and silicon, as represented by M(OR)ₙ. Here, as M, a monovalent to tetravalent element, preferably a divalent to tetravalent element is used. Preferable examples of the element include magnesium, aluminum, titanium, zirconium, boron and silicon. n corresponds to a valence number of an element M, and it is an integer of from 1 to 4, preferably an integer of from 2 to 4. Further, R is not particularly limited so long as it is an organic group. It is preferably an alkyl group having from 1 to 10 carbon atoms, and examples thereof include a methyl group, an ethyl group, a propyl group, an isopropyl group, an n-butyl group and the like. These alcoholates may be used either singly or in combination. Moreover, it is also possible to use a simple substance or an oxide of an element and an alcoholate thereof in combination.

A process for producing graphite grains in which graphite grains containing at least one element selected from metals, boron and silicon are produced by induction heating of carbon black, an oxide of at least one element selected from metals, boron and silicon and a metal reducing the oxide is also preferable because heat generated by burning synthesis can be used. By such a combination, it is possible that a metal reduces an oxide and an element constituting an oxide is contained in graphite. For example, when carbon black, aluminum and boron oxide are heated, boron oxide is first reduced with aluminum to form a simple substance of boron which is reacted with carbon black to obtain boron carbide. This is shown by the following chemical formula.

4Al+2B₂O₃+xC→2Al₂O₃+B₄C+(x−1)C

Further, a chemical formula in case of reacting carbon black, aluminum and titanium oxide is as follows.

4Al+3TiO₂+xC→2Al₂O₃+3TiC+(x−3)C

These reactions are also exothermic reactions. Burning synthesis is possible, and graphitization can be conducted even though a temperature inside a furnace is not so high.

The graphite grains produced by the foregoing processes can be used in various applications. The graphite grains are especially useful when used as a refractory raw material. A refractory obtained by molding a composition containing a refractory filler and the graphite grains produced by the foregoing processes are a useful embodiment of the invention. Since the graphite grains are developed in crystal structure as compared to carbon black, they are a material which has a high oxidation-initiating temperature, is excellent in oxidation resistance and also in corrosion resistance, and has a high thermal conductivity. The use of fine graphite grains in the nanometer order can divide pores to control the porous structure and further improve the corrosion resistance and the oxidation resistance of grains per se, with the result that a refractory excellent in thermal shock resistance, corrosion resistance and oxidation resistance is obtained.

The refractory filler mixed with the graphite grains in the invention is not particularly limited, and various refractory fillers can be used on the basis of the purpose and the required properties as refractories. Refractory oxides such as magnesia, calcia, alumina, spinel and zirconia, carbides such as silicon carbide and boron carbide, borates such as calcium borate and chromium borate, and nitrates can be used as the refractory filler. Of these, magnesia, alumina and spinel are preferable in consideration of usefulness of the low carbon content, and magnesia is most preferable. As magnesia, an electro-fused or sintered magnesia clinker is mentioned. These refractory fillers are incorporated after adjusting the grain size.

At this time, a refractory raw material composition comprising 100 parts by weight of the refractory filler and from 0.1 to 10 parts by weight of the graphite grains is preferable. When the mixing amount of the graphite grains is less than 0.1 part by weight, the effects provided by the addition of the graphite grains are, in many cases, little found. It is preferably 0.5 part by weight or more. Meanwhile, when the mixing amount of the graphite grains exceeds 10 parts by weight, the carbon pickup drastically occurs, the heat dissipation from containers also heavily occurs, and the corrosion resistance is decreased. It is preferably 5% by weight or less.

Moreover, as the binder used in the refractory raw material composition of the invention, an ordinary organic binder or inorganic binder can be used. As a highly refractory binder, the use of an organic binder such as a phenol resin or a pitch is preferable. In view of a wettability of a refractory raw material or a high content of residual carbon, a phenol resin is more preferable. The content of the organic binder is not particularly limited. It is appropriately from 1 to 5 parts by weight per 100 parts by weight of the refractory filler.

In the refractory raw material composition for obtaining the refractories of the invention, the graphite grains are used as a carbonaceous raw material. The graphite grains and another carbonaceous raw material may be used in combination. For example, incorporation of ungraphitized carbon black incurs lower cost than graphitized carbon black. In view of the balance of cost and properties, it is sometimes preferable to use a mixture of both carbon blacks. Further, for the same reason, another graphite ingredient such as flake graphite or expanded graphite may be used in combination, or a pitch, a coke or the like may be used in combination.

The refractory raw material composition of the invention may contain ingredients other than the foregoing unless the gist of the invention is impaired. For example, metallic powders such as aluminum and magnesium, alloy powders, silicon powders and the like may be contained therein. Further, in kneading, an appropriate amount of water or a solvent may be added.

The refractory of the invention is obtained by kneading the thus-obtained refractory raw material composition, molding the composition, and as required, heating the molded product. Here, in the heating, the product may be baked at a high temperature. However, in case of magnesia, the product is only baked at a temperature of, usually, less than 400° C.

A so-called monolithic refractory is included in the refractory raw material composition of the invention when the refractory is monolithic. When the monolithic refractory comes to have a certain form, it is considered to be the molded refractory. For example, even a product sprayed on a furnace wall is the molded refractory so long as it has a certain shape.

Since the thus-obtained refractory is excellent in corrosion resistance, oxidation resistance and thermal shock resistance, it is quite useful as a furnace material for obtaining a high-quality metallurgical product.

### BEST MODE FOR CARRYING OUT THE INVENTION

The invention is illustrated below by referring to Examples.

In Examples, analysis and evaluation were performed by various methods to follow.

(1) Method for Observing an Average Grain Size

A sample was photographed with 100,000× magnification using a transmission electron microscope. From the resulting photograph, a number average value of a size was obtained. At this time, when grains of the sample are aggregated, these were considered to be separate grains, and a value was obtained as an average primary grain size.

(2) Method for Calculating Graphite Lattice Spacing

A graphite powder to be intended was measured using a powder X-ray diffractometer. A measurement wavelength λ is 1.5418 Å, a wavelength of Kα rays of copper. Of crystal peaks obtained by the X-ray diffraction measurement, a large peak of which the value of 2θ is present near 26° is a peak corresponding to a 002 surface of graphite. From this, the lattice spacing d(Å) of graphite was calculated using the following formula.

d=λ/2 sinθ

(3) Apparent Porosity and bulk Specific Gravity after Treatment at 1,400° C.

A sample cut to 50×50×50 mm was embedded in a coke within an electric furnace, and heat-treated in an atmosphere of carbon monoxide at 1,400° C. for 5 hours. The treated sample was allowed to cool to room temperature, and an apparent porosity and a bulk specific gravity were then measured according to JIS R2205.

(4) Dynamic Elastic Modulus

A sample of 110×40×40 mm was embedded in a coke within an electric furnace, and heat-treated in an atmosphere of carbon monoxide at 1,000° C. or 1,400° C. for 5 hours. The treated sample was allowed to cool to room temperature, and an ultrasonic wave propagation time was measured using an ultrasony scope. A dynamic elastic modulus E was obtained on the basis of the following formula.

E=(L/t)²·ρ

wherein L is an ultrasonic wave propagation distance (length of a sample) (mm), t is an ultrasonic wave propagation time (μsec), and ρ is a bulk specific gravity of a sample.

(5) Oxidation Resistance Test

A sample of 40×40×40 mm was kept in an electric oven (ambient atmosphere) at 1,400° C. for 10 hours, and then cut. Thicknesses of decarbonized layers of three surfaces except a lower surface were measured at the cut face, and an average value thereof was calculated.

(6) Corrosion Resistance Test

A sample of 110×60×40 mm was installed on a rotary corrosion tester, and a test was conducted in which a step of keeping the sample in a slag with a basicity (CaO/SiO₂)=1 held at from 1,700 to 1,750° C. was repeated five times. A wear size was measured in a cut surface after the test.

### SYNTHESIS EXAMPLE 1

### Production of Graphite Grains a

“HTC #20” made by Nippon Steel Chemical Carbon Co., Ltd. was used as a carbon black raw material. This carbon black is carbon black of the type called FT (fine thermal) in which the average primary grain size is 82 nm. This raw material was filled in a carbon crucible having a diameter of 60 mm, a height of 30 mm and a thickness of 1 mm.

A coil was produced by winding a copper pipe having a diameter of 8.2 mm trifold to an outer diameter of 225 mm and a height of 50 mm. The carbon crucible filled with the foregoing sample was put in a silicon nitride crucible having an outer diameter of 190 mm, an inner diameter of 110 mm and a height of 110 mm placed within the coil. Silica sand was charged under and around the carbon crucible as an insulating material for effective heating.

After the sample was placed, a high frequency of 70 kHz and 12 kW was applied to the coil from a high frequency generator for 9 minutes. During this time, the change in temperature was measured with a thermocouple inserted in the sample powder. Then, the maximum temperature was 1,850° C. When the resulting grains were subjected to the X-ray diffraction measurement, a peak ascribable to a graphite structure was observed, and it was found that graphite grains were formed. Lattice spacing calculated from a diffraction line corresponding to 002 spacing of graphite was 3.40 Å. The average primary grain size of the grains was 70 nm.

### SYNTHESIS EXAMPLE 2

### Synthesis of Graphite Grains b

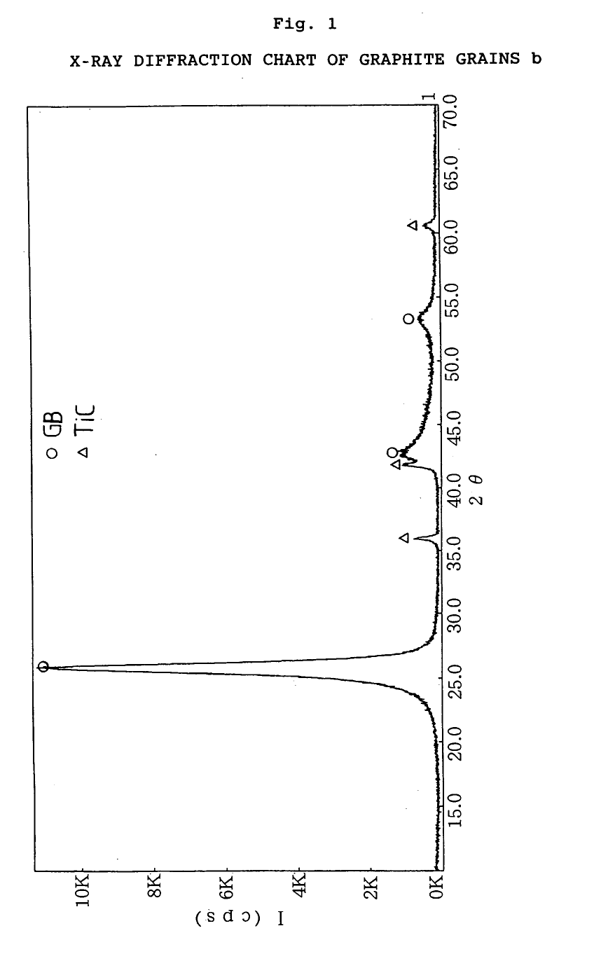

Graphite grains b were obtained in the same manner as in Synthesis Example 1 except that the same carbon black as used in Synthesis Example 1 and a titanium powder were mixed such that a molar ratio of a carbon element to a titanium element was 100:1. During this time, the change in temperature was measured with a thermocouple inserted in the sample powder. Then, the abrupt increase in temperature was observed from approximately 200° C., and an exothermic reaction started. When the resulting grains were subjected to the X-ray diffraction measurement, a peak ascribable to a graphite structure was observed, and it was found that graphite grains were formed. Lattice spacing calculated from a diffraction line corresponding to 002 spacing of graphite was 3.44 Å. Further, a peak with 2θ=41.5° ascribable to a 200 diffraction line of TiC was also observed. The X-ray diffraction chart is shown in FIG. 1. The average primary grain size of the grains was 71 nm.

### SYNTHESIS EXAMPLE 3

### Synthesis of Graphite Grains c

Graphite grains c were obtained in the same manner as in Synthesis Example 1 except that the same carbon black as used in Synthesis Example 1 and trimethoxyborane were mixed such that a molar ratio of a carbon element to a boron element was 50:1. During this time, the change in temperature was measured with a thermocouple inserted in the sample powder. Then, the abrupt increase in temperature was observed from approximately 1,400° C., and an exothermic reaction started. When the resulting grains were subjected to the X-ray diffraction measurement, a peak ascribable to a graphite structure was observed, and it was found that graphite grains were formed. Lattice spacing calculated from a diffraction line corresponding to 002 spacing of graphite was 3.41 Å. Further, a peak with 2θ=37.8° ascribable to a 021 diffraction line of B₄C was also observed. The average primary grain size of the grains was 72 nm.

### SYNTHESIS EXAMPLE 4

### Synthesis of Graphite Grains d

Graphite grains d were obtained in the same manner as in Synthesis Example 1 except that the same carbon black as used in Synthesis Example 1, an aluminum powder and a boron oxide powder were mixed such that a molar ratio of a carbon element to an aluminum element and a boron element was 10:2:1. During this time, the change in temperature was measured with a thermocouple inserted in the sample powder. Then, the abrupt increase in temperature was observed from approximately 1,400° C., and an exothermic reaction started. When the resulting grains were subjected to the X-ray diffraction measurement, a peak ascribable to a graphite structure was observed, and it was found that graphite grains were formed. Lattice spacing calculated from a diffraction line corresponding to 002 spacing of graphite was 3.41 Å. Further, a peak with 2θ=43.4° ascribable to a 113 diffraction line of Al₂O₃ and a peak with 2θ=37.8° ascribable to a 021 diffraction line of B₄C. were also observed. The average primary grain size of the grains was 70 nm.

With respect to the graphite grains a to d obtained in Synthesis Examples 1 to 4, the raw materials, the resulting compound and the average grain size were all shown in Table 1.

TABLE 1

| | | Syn- | Syn- | Syn- | Syn- |
|---|---|---|---|---|---|
| | | thesis | thesis | thesis | thesis |
| | | Exam- | Exam- | Exam- | Exam- |
| | | ple 1 | ple 2 | ple 3 | ple 4 |
| Raw | FT (HTC #20) | 100 | 100 | 100 | 100 |
| materials | titanium powder | | 1 | | |
| *1) | aluminum powder | | | | 20 |
| | Trimethoxyborane | | | 2 | |
| | boron oxide | | | | 10 |

| | | | | |
|---|---|---|---|---|
| Resulting graphite grains | a | B | c | d |
| Resulting mineral | C | C | C | C |
| | | TiC | B₄C | B₄C |
| | | | | Al₂O₃ |
| Average grain size (nm) | 70 | 71 | 72 | 70 |

*1) The figure is a mixing molar ratio of a raw element.

### EXAMPLE 1

100 parts by weight of electro-fused magnesia having a purity of 98% with a grain size adjusted, 2 parts by weight of the graphite grains A obtained in Synthesis Example 1 and 3 parts by weight of a phenol resin (obtained by adding a curing agent to a novolak-type phenol resin) were mixed, and kneaded with a kneader. After the mixture was molded with a friction press, the molded product was baked at 250° C. for 8 hours. Consequently, after the heat treatment at 1,400° C., the apparent porosity was 8.6%, and the bulk density was 3.13. Further, after the heat treatment at 1,000° C., the dynamic elastic modulus was 17.2 GPa, and after the heat treatment at 1,400° C., the dynamic elastic modulus was 19.7 GPa. Moreover, the thickness of the decarbonized layer was 6.0 mm, and the wear size was 10.2 mm.

### EXAMPLES 2 TO 4, AND COMPARATIVE EXAMPLES 1 TO 3

Refractories were produced in the same manner as in Example 1 except that the mixing raw materials were changed as shown in Table 2, and they were evaluated. The results are all shown in Table 2.

TABLE 2

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Mixing raw | Magnesia | 100 | 100 | 100 | 100 | 100 | 100 | 100 |
| materials *1) | graphite a | 2 | | | | | | |
| | graphite b | | 2 | | | | | |
| | graphite c | | | 2 | | | | |
| | graphite d | | | | 2 | | | |
| | FT (HTC #2) | | | | | 2 | | |
| | flake graphite | | | | | | 5 | |
| | expanded graphite | | | | | | | 5 |
| | phenol resin | 3 | 3 | 3 | 3 | 3 | 3 | 3 |

| | | | | | | | |
|---|---|---|---|---|---|---|---|
| Apparent porosity (%) | 8.6 | 8.9 | 8.8 | 8.7 | 8.7 | 9.2 | 12.4 |
| after 1,400° C. heat treatment | | | | | | | |
| Bulk specific gravity | 3.13 | 3.12 | 3.12 | 3.13 | 3.12 | 3.06 | 2.99 |
| after 1,400° C. heat treatment | | | | | | | |
| Dynamic elastic modulus (Gpa) | 17.2 | 17.4 | 18.0 | 19.0 | 17.4 | 28.6 | 22.6 |
| after 1,000° C. heat treatment | | | | | | | |
| Dynamic elastic modulus (Gpa) | 19.7 | 18.9 | 19.1 | 18.7 | 19.2 | 27.1 | 20.9 |
| after 1,400° C. heat treatment | | | | | | | |
| Thickness of decarbonized layer (mm) | 6.0 | 5.4 | 5.1 | 4.7 | 8.0 | 10.9 | 11.2 |
| Wear size (mm) | 10.2 | 8.9 | 9.0 | 9.2 | 11.1 | 17.8 | 19.0 |

*1) The mixing ratio is a weight ratio.

In case of using graphitized carbon black shown in Example 1, in comparison to the case of containing 5 parts by weight of flake graphite shown in Comparative Example 2 or expanded graphite shown in Comparative Example 3, the dynamic elastic modulus is low, the excellent thermal shock resistance is obtained with the less carbon content, the thickness of the decarbonized layer and the wear size are also small, and the excellent oxidation resistance and corrosion resistance are shown. Further, Example 1 shows the small thickness of the decarbonized layer, the small wear size, the excellent oxidation resistance and the excellent corrosion resistance in comparison to the case of using ungraphitized carbon black shown in Comparative Example 1. These facts prove the superiority of using the graphite grains obtained by the process of the invention.

Still further, in Examples 2 to 4 using the graphite grains containing boron, titanium or aluminum, in comparison to Example 1 which is the graphite grains free from these elements, it is found that the thickness of decarbonized layer and the wear size are smaller and the oxidation resistance and the corrosion resistance are more improved.

Industrial Applicability

The process for producing the graphite grains in the invention can easily proceed with the graphitization of carbon black which requires quite a high temperature in an ordinary heating method. Further, the use of the resulting graphite grains as a refractory raw material can provide the refractories excellent in thermal shock resistance, oxidation resistance and corrosion resistance with the carbon content reduced.

1. A process for producing graphite grains, characterized by graphitizing carbon black by induction heating in an induction furnace.

2. The process for producing graphite grains as claimed in claim 1, wherein carbon black having an average grain size of 500 nm or less is graphitized.

3. The process for producing graphite grains as claimed in claim 1 or 2, wherein graphite grains containing at least one element selected from metals, boron and silicon are produced by induction heating of carbon black and a simple substance of at least one element selected from metals, boron and silicon or a compound containing the element.

4. The process for producing graphite grains as claimed in claim 3, wherein carbon black and a simple substance of at least one element selected from boron, aluminum, silicon, calcium, titanium and zirconium are subjected to induction heating.

5. The process for producing graphite grains as claimed in claim 3, wherein carbon black and an alcoholate of at least one element selected from metals, boron and silicon are subjected to induction heating.

6. The process for producing graphite grains as claimed in claim 3, wherein carbon black, an oxide of at least one element selected from metals, boron and silicon and a metal reducing the oxide are subjected to induction heating.

7. A refractory which is obtained by molding a composition containing a refractory filler and the graphite grains produced by the process as claimed in any of claims 1 to 6.
